(19) United States
(12) Patent Application Publication
(10) Pub. No.: US 2025/0379535 A1
(43) Pub. Date: Dec. 11, 2025

(54) MOTOR DRIVE DEVICE AND MOTOR DRIVE SYSTEM

(71) Applicant: ISUZU MOTORS LIMITED, Yokohama-shi (JP)

(72) Inventors: Yusuke TAKAHASHI, Fujisawa-shi (JP); Noboru NIGUCHI, Osaka (JP); Yasuhisa KODAMA, Nakatsugawa-shi (JP)

(21) Appl. No.: 19/209,852

(22) Filed: May 16, 2025

(30) Foreign Application Priority Data
Jun. 5, 2024 (JP) 2024-091520

(51) Int. Cl. H02P 25/092

(52) U.S. Cl. CPC H02P 25/092

(57) ABSTRACT

A motor drive device includes an inverter part in which a plurality of switch arms are connected in parallel, a diode part that includes a pair of diodes, for each of the switch arms, including a first diode and a second diode, and a switch controller that controls voltage to be applied to gates of the first switch valves and the second switch valves included in the inverter part.

### CROSS-REFERENCE TO RELATED APPLICATIONS

The present application claims priority to Japanese Patent Application number 2024-091520, filed on Jun. 5, 2024, contents of which are incorporated herein by reference in its entirety.

### BACKGROUND OF THE INVENTION

The present disclosure relates to a motor drive device and a motor drive system.

A conventional motor device converts DC current into AC current using an inverter in which three sets of switch groups, each switch group including a first switch whose source is connected to a power supply, a second switch whose drain is grounded, and a diode provided between a drain of the first switch and a source of the second switch are connected in parallel, thereby driving a switched reluctance motor (for example, Japanese Unexamined Patent Application Publication No. 2023-79746).

A circuit configuration of a conventional inverter differs from that of an inverter mass-produced for driving a general-purpose motor such as a three-phase motor (a so-called general-purpose inverter). Therefore, it is necessary to newly create an inverter. In creating an inverter, it is necessary to enlarge a component such as a switch that constitutes the inverter according to the output of a switched reluctance motor and to design a protection circuit to prevent the inverter from outputting an overcurrent.

As a result, there is a problem in that the inverter cannot be easily created.

### BRIEF SUMMARY OF THE INVENTION

The present disclosure focuses on this point, and an object thereof is to drive a switched reluctance motor using a general-purpose inverter.

A first aspect of the present disclosure provides a motor driving device for driving a switched reluctance motor, the switched reluctance motor including i) a rotor rotatably disposed about a rotary shaft and having a plurality of salient poles formed on its outer circumference and ii) a stator disposed around the outside of the rotor and having a plurality of tooth portions formed on its inner circumference, wherein a winding of one phase among windings of a plurality of phases is wound around each of the plurality of tooth portions, and the windings of the plurality of phases are connected in series in an annular shape, the motor drive device includes an inverter part that is composed of a first switch valve whose source is connected to a power supply and a second switch valve whose drain is connected to a ground, and a plurality of switch arms, connecting a drain of the first switch valve and a source of the second switch valve, are connected in parallel, a diode part that includes a pair of diodes for each of the switch arms, the pair of diodes i) including a first diode whose anode is connected to a connecting point between a drain of the first switch valve and a source of the second switch valve and a second diode whose cathode is connected to the connecting point, and ii) having a) a cathode of the first diode being connected to a first connection that serially connects two adjacent windings, and b) an anode of the second diode being connected to a second connection that serially connects two adjacent windings, different from the first connection, and a switch controller that controls voltage to be applied to gates of the first switch valves and the second switch valves included in the inverter part.

### BRIEF DESCRIPTION OF THE DRAWINGS

FIG. 1 shows an overview of a circuit configuration of a motor drive system 1.

FIG. 2 shows an overview of a structure of a motor 2.

FIG. 3 shows a configuration of a switch controller 30.

FIG. 4 shows a calculated electrical angle and switches for performing chopper control.

FIG. 5 shows a circuit configuration of the motor drive system 1 according to a second modified example.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### <Overview of Motor Drive System 1>

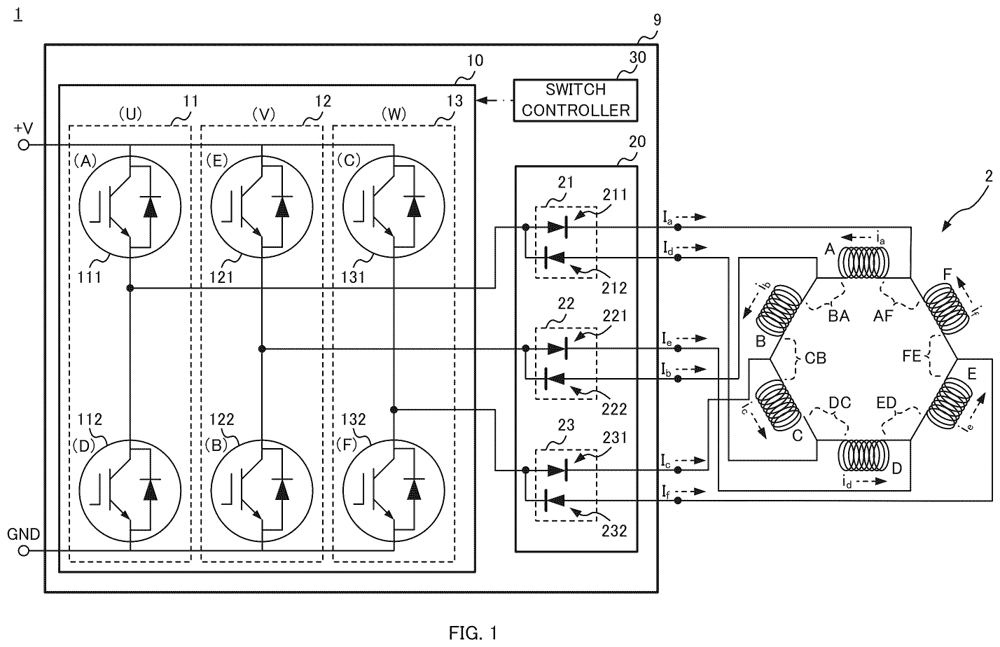

FIG. 1 shows an overview of a circuit configuration of a motor drive system 1. The motor drive system 1 shown in FIG. 1 includes a motor 2 and a motor drive device 9. The motor drive system 1 has a function of receiving electricity and outputting mechanical energy according to a user's request. As one example, when the motor drive system 1 is mounted on a vehicle, the user is a driver of the vehicle, and the motor drive system 1 is a system that outputs mechanical energy corresponding to an amount the driver depresses an accelerator pedal.

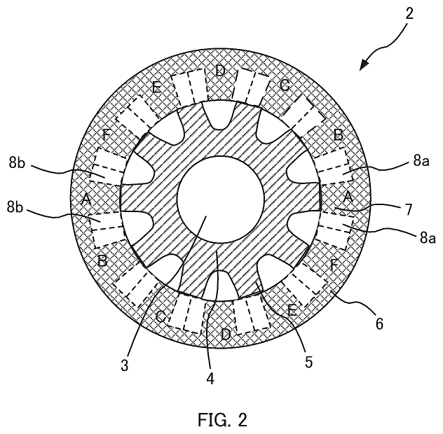

A motor 2 is, for example, a Switched Reluctance Motor (SRM), which is an electric motor that outputs mechanical energy by rotating a rotor, composed of a ferromagnetic iron core, using a magnetic field generated around a coil wound around a stator. FIG. 2 shows an overview of a structure of the motor 2. FIG. 2 is a cross-sectional view taken along a plane perpendicular to the axial direction of a rotary shaft of the motor 2. The motor 2 includes a rotary shaft 3, a rotor 4, and a stator 6.

The rotor 4 is a rotor which is disposed so as to be rotatable about the rotary shaft 3 and has a plurality of salient poles 5 (ten salient poles 5 in FIG. 2) formed on its outer circumference. The salient poles 5 formed on the outer circumference of the rotor 4 are composed of a ferromagnetic material. It should be noted that, in FIG. 2, one salient pole 5 out of the plurality of salient poles 5 is denoted by a reference numeral, as an example.

The stator 6 is a stator disposed around the outside of the rotor 4 and having a plurality of tooth portions 7 formed on its inner circumference. Each of the plurality of tooth portions 7 has a winding of one phase out of the plurality of phase windings (coils) wound around it. The plurality of phases includes, for example, six phases: phase A, phase B, phase C, phase D, phase E, and phase F. In FIG. 2, as an example, one of the plurality of tooth portions 7 is denoted with a reference numeral, and the tooth portion 7 denoted with the reference numeral has a partial winding 8a, out of the partial winding 8a and a partial winding 8b constituting the winding of phase A, wound around it. The partial winding 8a and the partial winding 8b are connected in series. The windings of phases other than phase A among the plurality of phase windings also have the same configuration as the winding of phase A.

Returning to FIG. 1, the windings of the plurality of phases of the motor 2 include windings of phase A, phase B, phase C, phase D, phase E, and phase F, which are positioned counterclockwise, and the windings of the phase A, the phase B, the phase C, the phase D, the phase E, and the phase F are connected in series in an annular shape in this order. Therefore, the motor 2 is provided with a plurality of connections that serially connect two adjacent windings, such as a connection AF, a connection FE, a connection ED, a connection DC, a connection CB, and a connection BA. It should be noted that the difference in electrical angle between each of the phase A and the phase F, the phase F and the phase E, the phase E and the phase D, the phase D and the phase C, the phase C and the phase B, and the phase B and the phase A is 60 degrees.

The motor driving device 9 is a device for driving the motor 2 (SRM), and is a so-called inverter. The motor drive device 9 receives electricity and performs chopper control such as Pulse Width Modulation (PWM) control to output electricity at a frequency corresponding to the rotational speed required for the motor 2.

A three-phase induction motor (a so-called general-purpose motor) can be driven by connecting it to an inverter (a so-called general-purpose inverter) formed of three parallel-connected switch arms, each of which has two switch valves connected in series. However, the inverter for driving the motor 2 (SRM) differs from a general-purpose inverter, so it is necessary to determine the size of a component constituting the inverter and to design a protection circuit to prevent the inverter from outputting overcurrent.

Accordingly, in the motor drive device 9, a bidirectional diode is connected downstream of the general-purpose inverter, and electricity is output from the bidirectional diode to the motor 2. With this configuration, the motor drive device 9 can divide each phase of the three-phase general-purpose inverter, which is composed of three switch arms connected in parallel, into a phase that supplies current and a phase that draws current, allowing the general-purpose inverter to be used as a six-phase inverter. Further, the motor drive device 9 can drive the motor 2 (SRM) by controlling a switch included in the general-purpose inverter on the basis of the electrical angle corresponding to the mechanical angle of the motor 2.

### <Configuration of Motor Drive Device 9>

As shown in FIG. 1, the motor drive device 9 includes an inverter part 10, a diode part 20, and a switch controller 30.

The inverter part 10 is a so-called general-purpose inverter, and has a configuration in which a plurality of switch arms are connected in parallel. The inverter part 10 shown in FIG. 1 includes, as switch arms, a U-phase arm 11 (first switch arm), a V-phase arm 12 (second switch arm), and a W-phase arm 13 (third switch arm) connected in parallel.

The switch arm is composed of an upper switch (first switch valve), whose source is connected to a power supply, and a lower switch (second switch valve), whose drain is connected to the ground, and the drain of the upper switch and the source of the lower switch are connected. In FIG. 1, an upper switch 111 and a lower switch 112 included in the U-phase arm 11, an upper switch 121 and a lower switch 122 included in the V-phase arm 12, and an upper switch 131 and a lower switch 132 included in the W-phase arm 13 are connected to each other.

It should be noted that, in the following description, the upper switch 111 is referred to as an A-phase switch 111, the upper switch 121 is referred to as an E-phase switch 121, the upper switch 131 is referred to as a C-phase switch 131, the lower switch 112 is referred to as a D-phase switch 112, the lower switch 122 is referred to as a B-phase switch 122, and the lower switch 132 is referred to as an F-phase switch 132. Further, in the following description, at least one of the A-phase switch 111, the E-phase switch 121, or the C-phase switch 131 is referred to as the “upper switch,” and at least one of the D-phase switch 112, the B-phase switch 122, or the F-phase switch 132 is referred to as the “lower switch.”

The diode part 20 is a circuit for inputting the output of the inverter part 10 to the motor 2, and has a bidirectional diode (a pair of diodes) for each switch arm. Specifically, the diode part 20 shown in FIG. 1 includes a bidirectional diode 21 connected downstream of the U-phase arm 11, a bidirectional diode 22 connected downstream of the V-phase arm 12, and a bidirectional diode 23 connected downstream of the W-phase arm 13.

Each bidirectional diode includes a first diode whose anode is connected to a connecting point between the drain of the upper switch and the source of the lower switch, and a second diode whose cathode is connected to that connecting point. In the bidirectional diode, the cathode of the first diode is connected to a first connection that serially connects two adjacent windings, and the anode of the second diode is connected to a second connection, different from the first connection, that serially connects two adjacent windings. Further, the anodes of the plurality of first diodes and the cathodes of the plurality of second diodes, included in the diode part 20, are respectively connected to different connecting points.

Specifically, the bidirectional diode 21 includes a first diode 211 whose anode is connected to a connecting point between the drain of the A-phase switch 111 and the source of the D-phase switch 112, and a second diode 212 whose cathode is connected to that connecting point. The cathode of the first diode 211 is connected to a first connection (the connection AF), which serially connects two adjacent windings (the winding of A-phase and the winding of F-phase). The anode of the second diode 212 is connected to a second connection (the connection DC), which is different from connection AF and serially connects two adjacent windings (the winding of D-phase and the winding of C-phase).

The bidirectional diode 22 includes a first diode 221 whose anode is connected to a connecting point between the drain of the E-phase switch 121 and the source of the B-phase switch 122, and a second diode 222 whose cathode is connected to that connecting point. The cathode of the first diode 221 is connected to the connection ED, which serially connects the winding of E-phase and the winding of D-phase, and the anode of the second diode 222 is connected to the connection BA, which serially connects the winding of B-phase and the winding of A-phase.

The bidirectional diode 23 includes a first diode 231 whose anode is connected to a connecting point between the drain of the C-phase switch 131 and the source of the F-phase switch 132, and a second diode 232 whose cathode is connected to that connecting point. The cathode of the first diode 231 is connected to the connection CB, which serially connects the winding of C-phase and the winding of B-phase, and the anode of the second diode 232 is connected to the connection FE, which serially connects the winding of F-phase and the winding of E-phase.

With the diode part 20 configured as described above, the diode part 20 can divide each of the three phases of the inverter part 10 into a phase that supplies current to the motor 2 and a phase that draws current from the motor 2. Furthermore, in the motor drive device 9, the inverter part 10 having the same configuration as that of the three-phase general-purpose inverter can be used as a six-phase inverter by connecting the diode part 2 downstream of the inverter part 10. As a result, in the motor drive device 9, the motor 2 (SRM) can be driven using a general-purpose inverter.

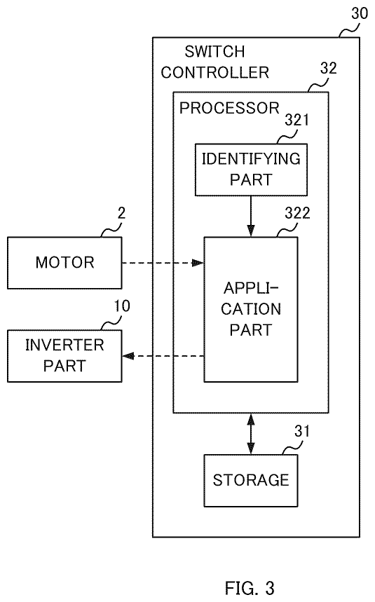

The switch controller 30 controls the electricity output from the motor drive device 9 to the motor 2 by controlling voltage to be applied to gates of the upper switches and lower switches in the inverter part 10. FIG. 3 shows a configuration of the switch controller 30. The switch controller 30 includes a storage 31 and a processor 32.

The storage 31 includes a storage medium such as a Read Only Memory (ROM), a Random Access Memory (RAM), a Hard Disk Drive (HDD), or a Solid State Drive (SSD), for example. The storage 31 stores a program executed by the processor 32 and various kinds of information for driving the motor 2.

The processor 32 is a processor such as a Central Processing Unit (CPU) or an Electronic Control Unit (ECU). The processor 32 functions as an identifying part 321 and an application part 322 by executing the program stored in the storage 31. It should be noted that the processor 32 may be configured as a single processor, or may be configured as a plurality of processors or a combination of one or more processors and an electronic circuit.

The identifying part 321 acquires a requested torque from an external ECU. The requested torque is a torque corresponding to an amount the driver depresses the accelerator pedal of the vehicle equipped with the motor drive system 1, for example. The identifying part 321 identifies the rotational speed of the motor 2 corresponding to the requested torque by referring to the storage 31, for example. Then, the identifying part 321 identifies the frequency of the electricity output by the motor driving device 9 corresponding to the identified rotational speed of the motor 2, by referring to the storage 31. That is, the identifying part 321 acquires the torque corresponding to the depression amount of the accelerator pedal, and identifies the frequency of electricity to be output for rotating the rotor of the motor 2 at the rotational speed corresponding to the torque.

The application part 322 controls the voltage to be applied to at least any of the gates of the plurality of upper switches and lower switches included in the inverter part 10. The application part 322 acquires the mechanical angle of the motor 2 detected by a rotation angle detection sensor (a so-called resolver, which is not shown in figures) included in the motor 2 at a predetermined cycle, for example. The application part 322 calculates an electrical angle corresponding to the acquired mechanical angle, and identifies a gate (switch) to be applied with voltage at the calculated electrical angle. That is, the application part 322 calculates the electrical angle corresponding to the mechanical angle of the motor 2 acquired at a predetermined cycle, and identifies the gate to be applied with voltage at the calculated electrical angle out of the gates of the plurality of first switch valves and the gates of the plurality of second switch valves. The application part 322 performs the chopper control by repeatedly starting and stopping the application of voltage to the identified gate, and causes the inverter part 10 to output electricity having the frequency identified by the identifying part 321.

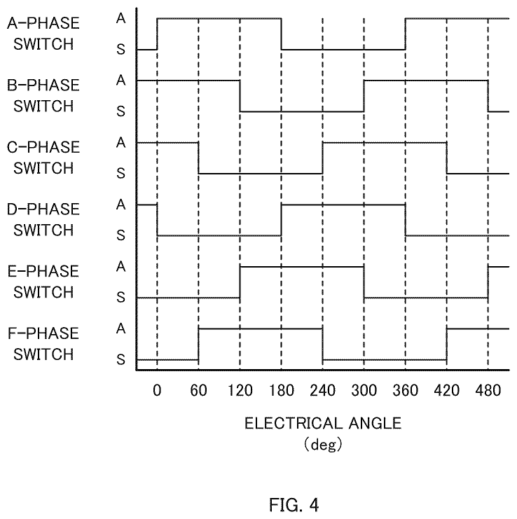

FIG. 4 shows the calculated electrical angle and the switches for performing the chopper control. The horizontal axis in FIG. 4 indicates the electrical angle, and the vertical axis in FIG. 4 indicates each switch included in the inverter part 10. The “A” shown on the vertical axis of FIG. 4 represents a state in which the chopper control is performed by repeatedly starting and stopping the application of voltage to the switch (gate), while the “S” shown on the vertical axis represents a state in which no application is made to the switch (that is, the chopper control is not performed). For example, when the electrical angle calculated by the application part 322 is 60 degrees, the application part 322 continues to start and stop the application of voltage to the gates of the A-phase switch 111 and the B-phase switch 122 (the chopper control), and does not perform the chopper control on the D-phase switch 112 and the E-phase switch 121. Further, the application part 322 stops the chopper control on the C-phase switch 131 and starts the chopper control on the F-phase switch 132.

As shown in FIG. 4, the switch controller 30 starts and stops the application of voltage so that the difference in electrical angle between each of the A-phase switch 111 and the B-phase switch 122, the B-phase switch 122 and the C-phase switch 131, the C-phase switch 131 and the D-phase switch 112, the D-phase switch 112 and the E-phase switch 121, the E-phase switch 121 and the F-phase switch 132, and the F-phase switch 132 and the A-phase switch 111 is 60 degrees. For example, the switch controller 30 starts application of voltage to the A-phase switch 111 at an electrical angle of 0 degrees, and then starts application of voltage to the F-phase switch 132 at an electrical angle of 60 degrees. After stopping the application of voltage to the A-phase switch 111 at the electrical angle of 180 degrees, the switch controller 30 stops the application of the voltage to the F-phase switch 132 at the electrical angle of 240 degrees.

Further, the switch controller 30 applies voltage to the gates of the plurality of upper switches and lower switches included in the inverter part 10, thereby supplying an offset current, which is DC superimposed on AC, to the diode part 2. The torque of the motor 2 varies according to the ratio of AC to DC flowing through the motor 2. Accordingly, by operating as described above, the motor drive system 1 can supply an offset current with a ratio of AC to DC that increases the torque of the motor 2. It should be noted that each offset current supplied to the motor 2 flows through either the first diode or the second diode of the diode part 20, and so the AC is not a sine wave but a half-wave. Consequently, each offset current contains only a DC component during a period when there is no AC component.

Here, the offset current flowing from the motor drive device 9 to the motor 2 (hereinafter referred to as “line current”) and the coil current flowing through each winding of the motor 2 will be described in detail.

As shown in FIG. 4, when the switch controller 30 controls each gate, the line currents Iₐ, I_{b}, I_{c}, I_{d}, Iₑ, and I_{f} shown in FIG. 1 can be given by Equations (1) to (6). I_{dc} represents a DC component, and I_{ac} represents an AC component.

$$\begin{matrix}[ Formula 1 ] & \\ {I}_{a} = {I}_{dc} + {I}_{ac} sin θ & ( 1 )\end{matrix}$$

$${I}_{b} = - {I}_{dc} + {I}_{ac} sin ( θ + \frac{4}{3} π ) \qquad ( 2 )$$

$${I}_{c} = {I}_{dc} + {I}_{ac} sin ( θ + \frac{2}{3} π ) \qquad ( 3 )$$

$${I}_{d} = - {I}_{dc} + {I}_{ac} sin θ \qquad ( 4 )$$

$${I}_{e} = {I}_{dc} + {I}_{ac} sin ( θ + \frac{4}{3} π ) \qquad ( 5 )$$

$${I}_{f} = - {I}_{dc} + {I}_{ac} sin ( θ + \frac{2}{3} π ) \qquad ( 6 )$$

Further, using the Kirchhoff's law, the coil currents iₐ, i_{b}, i_{c}, i_{d}, iₑ, and i_{f} shown in FIG. 1 can be expressed by Equations (7) to (12).

$$\begin{matrix}[ Formula 2 ] & \\ {i}_{a} = {I}_{a} + {i}_{f} & ( 7 )\end{matrix}$$

$${i}_{b} = {I}_{b} + {i}_{a} \qquad ( 8 )$$

$${i}_{c} = {I}_{c} + {i}_{b} \qquad ( 9 )$$

$${i}_{d} = {I}_{d} + {i}_{c} \qquad ( 10 )$$

$${i}_{e} = {I}_{e} + {i}_{d} \qquad ( 11 )$$

$${i}_{a} + {i}_{b} + {i}_{c} + {i}_{d} + {i}_{e} + {i}_{f} = 0 \qquad ( 12 )$$

Then, based on the above Equations (1) to (12), the coil currents iₐ, i_{b}, i_{c}, i_{d}, iₑ, and i_{f} can be expressed by Equations (13) to (18).

$$\begin{matrix}[ Formula 3 ] & \\ {i}_{a} = \frac{{I}_{dc}}{2} + \frac{1}{\sqrt{3}} {I}_{ac} sin ( θ + \frac{π}{6} ) & ( 13 )\end{matrix}$$

$${i}_{b} = - \frac{{I}_{dc}}{2} + \frac{1}{\sqrt{3}} {I}_{ac} sin ( θ + \frac{3 π}{2} ) \qquad ( 14 )$$

$${i}_{c} = \frac{{I}_{dc}}{2} + \frac{1}{\sqrt{3}} {I}_{ac} sin ( θ + \frac{5 π}{6} ) \qquad ( 15 )$$

$${i}_{d} = - \frac{{I}_{dc}}{2} + \frac{1}{\sqrt{3}} {I}_{ac} sin ( θ + \frac{π}{6} ) \qquad ( 16 )$$

$${i}_{e} = \frac{{I}_{dc}}{2} + \frac{1}{\sqrt{3}} {I}_{ac} sin ( θ + \frac{3 π}{2} ) \qquad ( 17 )$$

$${i}_{f} = - \frac{{I}_{dc}}{2} + \frac{1}{\sqrt{3}} {I}_{ac} sin ( θ + \frac{5 π}{6} ) \qquad ( 18 )$$

As shown in Equations (1) to (6) and Equations (13) to (18), each coil current flows with the electrical angle advanced by 30 degrees relative to each line current. Since each line current forms a six-phase AC, the motor drive device 9 can drive the motor 2, which is a six-phase SRM.

The line current and the coil current have been described above in detail.

### First Modified Example

The above description has exemplified the operation of the motor drive device 9 for driving the motor 2 (a so-called 12/10 SRM) that includes the rotor 4 with ten salient poles 5 formed on its outer circumference and the stator 6 with twelve tooth portions 7 formed on its inner circumference, but it is not limited thereto. The motor driving device 9 may drive the motor 2 (a so-called 12/8 SRM) including the rotor 4 with eight salient poles 5 formed on its outer circumference and the stator 6 with twelve tooth portions 7 formed on its inner circumference by the same operation as described above.

### Second Modified Example

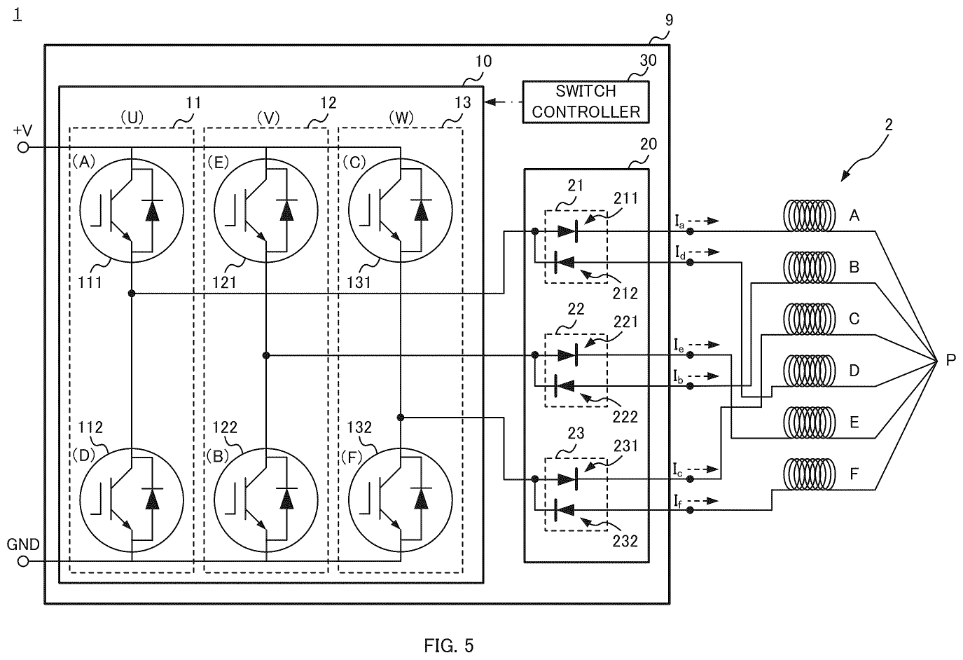

The above description has exemplified the operation of the motor 2 having the windings of phase A, phase B, phase C, phase D, phase E, and phase F connected in series in an annular shape in this order, but it is not limited thereto. The windings of phase A, phase B, phase C, phase D, phase E, and phase F may have one end connected to a neutral point. FIG. 5 shows a circuit configuration of the motor drive system 1 according to a second modified example. The motor drive system 1 shown in FIG. 5 is different from the motor drive system 1 shown in FIG. 1 in that the windings of phase A, phase B, phase C, phase D, phase E, and phase F have one end connected to a neutral point P, and is the same in other respects.

### <Effects of the Motor Drive Device 9>

As described above, the motor drive device 9 includes i) the inverter part 10 in which switch arms, formed by connecting the upper switch and the lower switch, are connected in parallel, and ii) the diode part 20 having a pair of diodes for each switch arm. The pair of diodes includes the first diode whose anode is connected to a connecting point between the upper switch and the lower stich and the second diode whose cathode is connected to that connecting point. The cathode of the first diode and the anode of the second diode are connected to a connection that serially connects two adjacent windings of the motor 2. The switch controller 30 included in the motor drive device 9 controls voltage to be applied to the upper switch and the lower switch, so that the motor drive device 9 drives the motor 2, which is an SRM, including the rotor 4 having the plurality of salient poles 5 formed on its outer circumference and the stator 6 having the plurality of tooth portions 7 formed on its inner circumference, wherein the windings wound around the plurality of tooth portions 7 are connected in series in an annular shape.

With the motor drive device 9 configured in this manner, the motor drive device 9 can drive the motor 2 serving as the SRM by using the inverter part 10 having the same configuration as an inverter (general-purpose inverter) for driving a general-purpose motor such as a three-phase motor. As a result, an inverter for driving the SRM can be easily formed.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A motor driving device for driving a switched reluctance motor, the switched reluctance motor including i) a rotor rotatably disposed about a rotary shaft and having a plurality of salient poles formed on its outer circumference and ii) a stator disposed around the outside of the rotor and having a plurality of tooth portions formed on its inner circumference, wherein a winding of one phase among windings of a plurality of phases is wound around each of the plurality of tooth portions, and the windings of the plurality of phases are connected in series in an annular shape, the motor drive device comprising:
an inverter part that is composed of a first switch valve whose source is connected to a power supply and a second switch valve whose drain is connected to a ground, and a plurality of switch arms, connecting a drain of the first switch valve and a source of the second switch valve, are connected in parallel;
a diode part that includes a pair of diodes for each of the switch arms, the pair of diodes i) including a first diode whose anode is connected to a connecting point between a drain of the first switch valve and a source of the second switch valve and a second diode whose cathode is connected to the connecting point, and ii) having a) a cathode of the first diode being connected to a first connection that serially connects two adjacent windings, and b) an anode of the second diode being connected to a second connection that serially connects two adjacent windings, different from the first connection; and
a switch controller that controls voltage to be applied to gates of the first switch valves and the second switch valves included in the inverter part.

2. The motor drive device according to claim 1, wherein
the switched reluctance motor is provided with a plurality of connections that serially connect two adjacent windings, and
the anodes of the plurality of first diodes and the cathodes of the plurality of second diodes included in the diode part are respectively connected to the different connections.

3. The motor drive device according to claim 1, wherein
the inverter part includes a first switch arm, a second switch arm, and a third switch arm connected in parallel.

4. The motor drive device according to claim 3, wherein
the windings of the plurality of phases of include windings of phase A, phase B, phase C, phase D, phase E, and phase F connected in series in an annular shape, and difference in electrical angle between each of the phase A and the phase F, the phase F and the phase E, the phase E and the phase D, the phase D and the phase C, the phase C and the phase B, and the phase B and the phase A is 60 degrees, and
the cathode of the first diode connected to the first switch arm is connected to a connection that serially connects the winding of phase A and the winding of phase F, and the anode of the second diode connected to the first switch arm is connected to a connection that serially connects the winding of phase D and the winding of phase C.

5. The motor drive device according to claim 4, wherein
the cathode of the first diode connected to the second switch arm is connected to a connection that serially connects the winding of phase E and the winding of phase D, and the anode of the second diode connected to the second switch arm is connected to a connection that serially connects the winding of phase B and the winding of phase A.

6. The motor drive device according to claim 4, wherein
the cathode of the first diode connected to the third switch arm is connected to a connection that serially connects the winding of phase C and the winding of phase B, and the anode of the second diode connected to the third switch arm is connected to a connection that serially connects the winding of phase F and the winding of phase E.

7. The motor drive device according to claim 3, wherein
the switch controller starts and stops the application of voltage so that difference in electrical angle between each of the first switch valve of the first switch arm and the second switch valve of the second switch arm, the second switch valve and the first switch valve of the third switch arm, the first switch valve and the second switch valve of the first switch arm, the second switch valve and the first switch valve of the second switch arm, the first switch valve and the second switch valve of the third switch arm, and the second switch valve and the first switch valve of the first switch arm is 60 degrees.

8. The motor drive device according to claim 1, wherein
the switch controller applies voltage to gates of the plurality of first switch valves and the plurality of second switch valves included in the inverter part, thereby supplying an offset current, which is DC superimposed on AC, to the diode part.

9. The motor drive device according to claim 1, wherein
the switch controller includes an application part that calculates an electrical angle corresponding to a mechanical angle of the switched reluctance motor acquired at a predetermined cycle, and identifies the gate to be applied with voltage at the calculated electrical angle among the gates of the plurality of first switch valves and the gates of the plurality of second switch valves.

10. The motor drive device according to claim 9, wherein
the switch controller further includes an identifying part that acquires a torque corresponding to a depression amount of an accelerator pedal and identifies a frequency of electricity output to rotate the rotor of the switched reluctance motor at a rotational speed corresponding to the torque, and
the application part performs chopper control by repeatedly starting and stopping application of voltage to the identified gate, and causes the inverter part to output electricity having a frequency identified by the identifying part.

11. A motor drive system comprising a motor and a motor drive device, wherein
the motor is a switched reluctance motor including i) a rotor rotatably disposed about a rotary shaft and having a plurality of salient poles formed on its outer circumference and ii) a stator disposed around the outside of the rotor and having a plurality of tooth portions formed on its inner circumference, wherein a winding of one phase among windings of a plurality of phases is wound around each of the plurality of tooth portions,
the motor drive device includes:
an inverter part that includes a first switch valve whose source is connected to a power supply and a second switch valve whose drain is connected to a ground, and a plurality of switch arms connecting a drain of the first switch valve and a source of the second switch valve are connected in parallel,
a diode part that includes a pair of diodes for each of the switch arms, the pair of diodes is i) including a first diode whose anode is connected to a connection between a drain of the first switch valve and a source of the second switch valve and a second diode whose cathode is connected to the connection, and ii) having a) a cathode of the first diode being connected to a first connection in which two adjacent windings are connected in series, and b) an anode of the second diode being connected to a second connection in which two adjacent windings different from the first connection are connected in series, and
a switch controller that controls voltage to be applied to gates of the first switch valve and the second switch valve included in the inverter part.

12. The motor drive system according to claim 11, wherein
the windings of the plurality of phases include windings of phase A, phase B, phase C, phase D, phase E, and phase F, and difference in electrical angle between each of the phase A and the phase F, the phase F and the phase E, the phase E and the phase D, the phase D and the phase C, the phase C and the phase B, and the phase B and the phase A is 60 degrees, and
windings of the phase A, the phase B, the phase C, the phase D, the phase E, and the phase F are connected in series in an annular shape in this order.

13. The motor drive system according to claim 11, wherein
the windings of the plurality of phases include windings of phase A, phase B, phase C, phase D, phase E, and phase F, and difference in electrical angle between each of the phase A and the phase F, the phase F and the phase E, the phase E and the phase D, the phase D and the phase C, the phase C and the phase B, and the phase B and the phase A is 60 degrees, and
windings of the phase A, the phase B, the phase C, the phase D, the phase E, and the phase F have one end connected to a neutral point.
